(19) United States
(12) Patent Application Publication
(10) Pub. No.: US 2015/0199955 A1
(43) Pub. Date: Jul. 16, 2015

(54) ENGINE SOUND SIMULATION FOR ELECTRIC VEHICLES

(71) Applicant: CloudCar Inc., Los Altos, CA (US)

(72) Inventor: Zarko Draganic, San Rafael, CA (US)

(73) Assignee: CloudCar Inc., Los Altos, CA (US)

(21) Appl. No.: 14/156,091

(22) Filed: Jan. 15, 2014

(51) Int. Cl. G10K 15/04; H04R 5/04; G08B 6/00; G10K 15/02

(52) U.S. Cl. CPC G10K 15/04; G10K 15/02; H04R 5/04; G08B 6/00; H04R 2499/13

(57) ABSTRACT

A system for providing a traditional driving experience in an electric vehicle can include: a computing system having one or more memory devices with traditional driving experience data of a fuel engine vehicle and computer executable instructions for performing a method for providing the traditional driving experience; one or more sensors to sense current driving and provide current driving data to the computing system; and an audio system to receive audio feedback data from the computing system in response to the current driving data and provide audio feedback that sounds like the fuel engine vehicle in the electric vehicle. In one aspect, the system can include a haptic feedback device configured to receive haptic feedback data from the computing system so that haptic feedback to simulate the fuel engine vehicle is provided to the electric vehicle, the haptic feedback data being part of the traditional driving experience data.

### BACKGROUND

The introduction of new electric vehicles (EVs) has befuddled many drivers because of the silent and smooth operation. Drivers are used to engine noises, gear shifting, throttle sounds, and the like.

Fisker has introduced an electric car named the Karma. This car uses external speakers mounted in the “exhaust” to simulate engine sound and warn people that the car is coming. However this approach does nothing to enhance the driving experience for the driver. There are also many car sound applications that are available for mobile devices, such as CarSounds, but these applications do not use a car's speed or engine RPM to create the realistic feedback to the driver. As such, the driver of the Fisker Karma or a driver using a sound application does not have a traditional automotive driving experience.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an embodiment of a vehicle-based system for providing a traditional driving experience in an electric vehicle in response to operation conditions of the electric vehicle.

FIG. 2 illustrates an embodiment of a mobile device-based system for providing a traditional driving experience in an electric vehicle in response to operation conditions of the electric vehicle.

FIG. 3 illustrates an embodiment of a system including an electric vehicle and mobile device for providing a traditional driving experience in an electric vehicle in response to operation conditions of the electric vehicle.

FIG. 4 illustrates an embodiment of electric vehicle stock and/or aftermarket components for providing sound and/or haptic feedback for a traditional driving experience in an electric vehicle in response to operation conditions of the electric vehicle

FIG. 5 illustrates an embodiment of a method for providing a traditional driving experience in an electric vehicle in response to operation conditions of the electric vehicle.

FIG. 6 illustrates an embodiment of computing system of the invention.

FIG. 7 illustrates an embodiment of a system for recording data of a traditional driving experience in a fuel vehicle for use in providing a traditional driving experience in an electric vehicle in response to operation conditions of the electric vehicle.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present invention includes a system and method for bringing a traditional driving experience to electric vehicles. As used herein, “traditional diving experience” means a driving experience that includes one or more of: realistic engine noises; gearshift sensation and feeling in the gear shifter and/or pedals; vibrations in the driving seat, pedals, gear shifter, steering wheel, etc.; accelerations; decelerations; and any other similar simulations from traditional gasoline or diesel powered vehicles. Accordingly, the system and method can provide the traditional driving experience to a driver and/or passengers of an electric vehicle. The system can include sensors, computing systems, and mechanical/audio devices that operate together to acquire driving data with sensors, process the driving data with the computing systems, and then implement the traditional driving experience with the mechanical/audio devices. The system and method can provide sound and feeling feedback to the driver in response to current driving scenarios and situations, such as acceleration, gear changing, or the like.

In one embodiment, the traditional driving experience can include a traditional driving sound. As such, the system can be configured to provide a traditional driving sound to the driver and passengers in an electric vehicle. The traditional diving sound can include for example, the sound of a fuel engine (e.g., gasoline, diesel, propane, natural gas, etc.) that matches the driving experience. That is, the sound that is emitted corresponds with the driving in acceleration, speed, gear shifting, or the like of a fuel engine being played within the electric vehicle.

In one embodiment, the traditional driving experience can include a traditional driving feel. As such, the system can be configured to provide a traditional driving feel to the driver and passengers in an electric vehicle. The traditional diving feel can include for example, the feel of a fuel engine (e.g., gasoline, diesel, propane, natural gas, etc.) that matches the driving experience. That is, the feel that is emitted from various components of the electric car corresponds with the driving in acceleration, speed, gear shifting, or the like of a fuel engine being played within the electric vehicle. The feel can be in vibrations of the components as well as the sensations of acceleration, deceleration, lag, or other sensations that occur during routine driving of a fuel vehicle. The feel can be from haptic feedback from vehicle components. The vehicle components can be standard in electric vehicles or aftermarket components that are not necessary for an electric vehicle. For example, the aftermarket components can include gear shift levers, clutch pedals, thrust buttons, or the like.

In one embodiment, the system and method can be implemented with an application for a mobile device, such as a smart phone (e.g., Droid, iPhone, Windows Phone, etc.). The application can utilize sensors in the mobile device that is in the electric vehicle being driven in order to determine current driving scenarios and situations, and then provide corresponding audio sound to the driver. The sensors in the mobile device can include GPS, accelerometer, gyroscope, magnetometer, barometer, proximity sensor, light sensor, touch sensor, microphone, or others, known or later developed. The sensor can obtain driving data, such as acceleration or speed, analyze the driving data, and then determine the traditional driving sound and/or feel to be provided to the driver. The mobile device can provide some or all of the traditional driving sound and/or feel. Also, the mobile device can provide traditional driving sound and/or feel data to the electric vehicle and/or aftermarket components and the electric vehicle and/or aftermarket components can provide the traditional driving sound and/or feel to the driver and passengers. The system and method can include hardware and software for the mobile device to connect to an electric vehicle, which can be a hard plug (e.g., USB) or wireless (e.g., Bluetooth). Data can be passed back and forth between the mobile device and electric vehicle in order to provide the traditional driving experience simulation.

In one embodiment, the system and method can be implemented with an electric vehicle without a mobile device. As such, the electric vehicle can include an application that functions substantially as the application for the mobile device. The electric vehicle can include the hardware and software to execute the application to provide the traditional driving sound and feel. The application can utilize sensors in the electric vehicle being driven in order to determine current driving scenarios and situations, and then provide corresponding audio sound to the driver. The sensors in the electric vehicle can include GPS, accelerometer, gyroscope, magnetometer, barometer, proximity sensor, light sensor, touch sensor, microphone, speedometer, or others, known or later developed. The sensors can obtain driving data, such as acceleration or speed, analyze the driving data, and then determine the traditional driving sound and/or feel to be provided to the driver. The electric vehicle can provide some or all of the traditional driving sound and/or feel. Also, the electric vehicle can provide traditional driving sound and/or feel data to aftermarket components and the electric vehicle and/or aftermarket components can provide the traditional driving sound and/or feel to the driver and passengers.

In one example, the system and method can be implemented to simulate the traditional driving experience to an electric vehicle. This can include starting the electric vehicle with a traditional fuel vehicle starter sound and feel, which can sound like rumbling and feel like vibrations of the starter engaging. The act of starting the electric vehicle can be input manually into the mobile device or the electric vehicle can provide the data to the mobile device. In an example, the mobile device can be operably coupled with the electric vehicle so that input into the mobile device can control the electric vehicle. This can include pushing a “start” icon (e.g., touch sensor) on the mobile device so that the electric vehicle starts, and the traditional starting sound and/or feel of a fuel vehicle are provided to the driver and passengers. After starting, the system and method can provide the traditional driving experience of an engine idling, which can include the traditional idling increasing and decreasing as a fuel engine warms up, which can be provided as idling sound and/or haptic feedback. As such, the sound and feel of a fuel engine running can be provided to the driver with the system and method.

In one example, the system and method can be configured to simulate an automatic transmission fuel vehicle to provide the traditional driving experience thereof. This embodiment can include the sound and feeling of an automatic transmission changing gears during acceleration. Also, this embodiment can include the sound and feeling of engaging an automatic transmission lever (e.g., which can be similar to the gear shift lever). As such, the automatic transmission lever can be an aftermarket component configured to operate with the present invention.

In one example, the system and method can be configured to simulate a manual transmission fuel vehicle to provide the traditional driving experience thereof. This embodiment may or may not include a clutch pedal and/or gear shift lever. When not included, the system and method can simulate use of a clutch pedal and/or gear shift lever in the driving sound and/or feel. For example, the lag of a clutch pedal being engaged can be heard and/or felt by the driver even when there is no such clutch pedal. Similarly, the disengagement and engagement sound and feeling of a gear shift lever being operated can be heard and/or felt by the driver even when there is no such gear shift lever.

In one embodiment, as the electric vehicle is ready to begin driving the system and method can be used to simulate the sound and feel engagement of an automatic and/or manual transmission.

In one embodiment, as the electric vehicle is ready to begin driving and the acceleration pedal is engaged the system and method can be used to simulate the sound and feel of a fuel vehicle engine accelerating, which can include engine sounds, transmission sounds, exhaust sounds, or any other acceleration sounds of a fuel vehicle. This can provide a cognitive satisfaction to drive the electric vehicle that simulates the sound and/or feel of the fuel vehicle during acceleration. This can be beneficial to drives that learned or are/were used to traditional fuel engine vehicles. During the acceleration phase, the system and method can obtain data related to the acceleration and rate of acceleration from the sensors, so that the acceleration data can be processed by the computing system in order to identify simulated acceleration sound and/or feel to be provided to the driver and passengers. The system and method can then provide the acceleration sound and feel to the driver and passengers. Thus, the system and method can determine the acceleration of the electric vehicle and then provide the traditional driving sound and feel of the fuel vehicle. In one example, the system and method obtains the acceleration data from sensors in the mobile device and/or electric vehicle, and the acceleration data are processed in the application of the mobile device and/or electric vehicle, and the mobile device and/or electric vehicle provides the traditional driving sound and/or feel simulation to the driver.

In one embodiment, the sound and/or feel of standard transmission gear shifting can be provided in the simulated traditional driving experience. This can be with or without a gear shift lever. When a gear shift lever is used, the vibrations and clunking of engagement and disengagement of the transmission can be simulated by the gear shift lever and passed to the driver's hand. When a gear shift lever is not used, such vibrations and clunking of using a gear shift lever can be simulated with sound and/or haptic feedback. Also, during gear shifting there are accelerations and decelerations of the vehicle, such as deceleration when the clutch is engaged, and acceleration once the clutch is disengaged and the gearing grabs. The system and method can simulate the sound and velocity/acceleration/deceleration that accompanies standard transmission gear shifting.

In one embodiment, the sound and/or feel of a fuel vehicle, such as the engine, transmission, and/or exhaust, can be provided to simulate the traditional driving experience. The simulation can be through various accelerations and acceleration rates, gear changes, and lag or decelerations that may be experienced in a fuel vehicle.

In one embodiment, the system and method can include a gear shift lever that is outfitted with haptic feedback devices. Electric vehicles may or may not include a gear shift lever due to the electric motor, and when included the gear shift lever can include the haptic feedback device as a manufactured component or haptic device added to the gear shift lever as an aftermarket component. An aftermarket gear shift lever can be provided for electric cars without a gear shift lever, and it may include the haptic feedback devices. For example, a servo mechanism or vibratory motor, or electro active, piezoelectric, electrostatic and subsonic audio wave surface actuation, audio haptics, electrostatic haptics, or the like. Additionally, other driving components, such as clutch pedals, steering wheels, automatic transmission levers, or the like can be included in an electric vehicle or as aftermarket components. In all situations, the sensors and haptic devices can be included in any of the driving components to facilitate the traditional driving experience, such as the feel or haptic feedback. The same concepts can be applied to paddle shifters, which can be included and/or simulated. In one example, a gear shift unit (e.g., USB Thrustmaster or similar) may be used to allow the user to shift through gear changes and feel haptic feedback, where the haptic feedback can be just like in a traditional car with a standard transmission.

In one embodiment, a seat in an electric vehicle can be outfitted with a haptic feedback device that operates with the systems and methods for providing the traditional driving experience to an electric vehicle. Alternatively, a seat cushion that can be placed on a car seat can include the haptic feedback devices. The seat can be a driver seat or any front or passenger seat. The haptic seat can provide the vibrational feelings of driving that is commonly felt in a fuel vehicle seat. The seat cushion can be a bottom and/or back seat cushion outfitted with the haptic feedback.

In one embodiment, the system and method can provide a traditional driving experience of any type of vehicle. That is, the type of traditional driving experience simulation can be selected, and the traditional driving experience of that type will be simulated. Accordingly, the system and method can include a database that has traditional driving experience simulation data for a range of vehicles. In one embodiment, different general types of vehicles can be simulated, such as sub-compact, compact, medium, sedan, sports cars, SUV, trucks, industrial vehicles, garbage trucks, dump trucks, semis, tractors, go-carts, ATV, UTV, motorcycle, or any other. The different types can also include different types of engines, such as 4-cylinder, boxer, V-6, 1-6, V8, V-10, rotary, diesel, propane, natural gas, turbo charged, supercharged, nitrocharged, motorcycle engines, 4-stroke, 2-stroke, V-twins, combination thereof, or any other. That is, the electric vehicle can provide the traditional driving experience of any type of vehicle even if it is different from the electric vehicle being driven. The traditional driving experience data for sound and feel can be obtained for any type of vehicle, and processed by the computing system, utilized so that the desired traditional driving experience can be obtained. In additional to sound and/or feel, the driving acceleration and speed of the electric vehicle can be provided to match and simulate any of these types of vehicles or engines. As such, the database can include a list of the different types of vehicles or engines that can be simulated in the electric vehicle, and a selection can be made. Then, the electric vehicle will actually drive like that vehicle as well as sound and feel like that vehicle. In an example, a dump truck vehicle can be selected with a diesel engine, and the electric vehicle can start, engage, drive, and brake like such a dump truck, which is usually slow and cumbersome. The simulation may also include simulated raising or lowering a fictional dump bed upon activating a selection. A graphical user interface, such as a touch screen, can be interacted with in order to make selections and to obtain secondary features, such as dump bed raising and lowering. In another example, the same electric vehicle can be used with a sports car selected, and the electric vehicle can drive, sound, and feel like a sports car. This can give a driver the satisfaction of selecting the driving mode to match a certain vehicle. Additionally, certain kinds of cars, such as Ferrari, Lamborghini, Lotus, and the models thereof can be selections for the vehicle type. In one instance, a bullet bike or cruzer motorcycle simulation can be used for the electric car vehicle.

In one embodiment, the system and method can be configured for any type of electric vehicle, ranging from electric cars, trucks, motorcycles, or any other.

In one embodiment, the driving type can be selected in the system and method. That is, the type of driving from slow and casual to fast and furious can be selected and the electric vehicle will perform to that type of driving as well as provide the sound and feel of that type of driving.

In one embodiment, various driving parameters can be selected. The parameters can be peek RPMs, or RPMS where a turbo or supercharger or nitrocharger kicks in.

In one embodiment, the environmental conditions that the driving will be performed in can be selected to modify the traditional driving experience of the electric vehicle. For example, selections of snow or rain can provide for a simulated driving condition that would occur in the snow or rain, wherein one example the electric vehicle can feel like the wheels are slipping when the roads are selected to be slick. However, the wheels of the electric vehicle may or may not be slipping; however, the electric vehicle can provide simulation so that the driving experience, sound and feel gives the sensation that the wheels are slipping on slick roads.

In one embodiment, the systems and methods of the invention include a sensor to measure electric motor speed (RPM) and/or car speed (e.g., in electric vehicle motor rotation per minute to speed is usually related 1:1). The systems and methods can also include hardware and software mechanisms to create audio sounds over the vehicle Hi-Fi stereo or other speaker or even through a mobile device. The system and method can pitch shift the audio according of an actual fuel engine vehicle to simulated fuel engine RPM to the electric vehicle. The system and method can obtain driving data from the sensors so that the driving style can be analyzed and a corresponding traditional driving experience simulation can be output. For example, the sensors can include GPS for speed, and an accelerometer for cornering and acceleration. For example, during hard driving and turning the system and method can provide simulated tire screeching even when the tires are not actually screeching.

In on example, a prototype of the invention using an Android phone, Fiat 500e, Bluetooth audio on the Fiat 500e, ODB-2 Bluetooth dongle, and Thrustmaster gear shift control, using Ferrari V12 engine sounds, was created and demonstrated. As such, the Fiat 500e sounded and felt like it had a Ferrari V12 engine.

In one embodiment, the system and method can be used to provide a traditional driving experience to electric cars, by adding realistic engine noises, gearshifts, vibrations and other similar “vintage” characteristics of traditional gasoline or diesel powered vehicles, into a modern electric vehicle. Sensory feedback is provided to the driver and passengers of an electric vehicle or other non-traditional car, to greatly enhance the driving experience by reminding the driver cognitively of a traditional gasoline or diesel powered driving experience, providing comfort, enjoyment and higher marketable value for a car when equipped with the systems and methods of the invention.

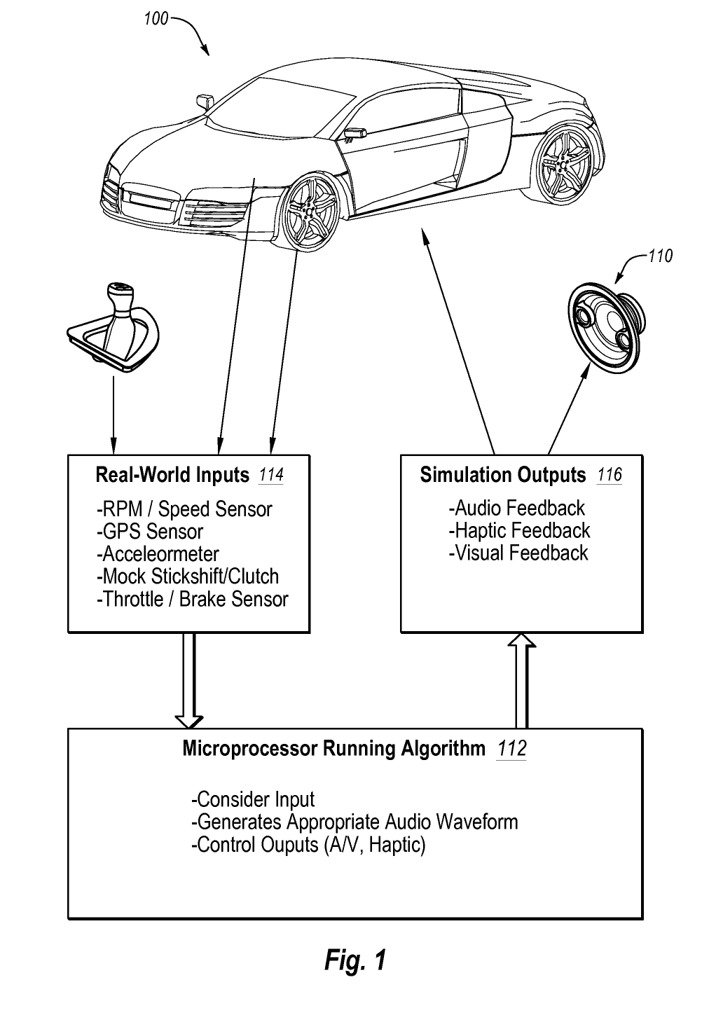

FIG. 1 illustrates an embodiment of a system of the present invention. As shown, the system can include an electric vehicle 100 having an in-vehicle sound system 110 and a computing system 112 to run the method for traditional driving experience simulation. The computing system 112 may be integrated with the electric vehicle 100, coupleable therewith, or provided in a mobile device. The computing system 112 can include hardware and software for implementing the method for traditional driving experience simulation. The system can include the sensors to obtain real-world inputs 114 that correspond with current driving of the electric vehicle 100. described herein, such as RPM sensor, speed sensor, GPS sensor, accelerometer, gear shifter (e.g., stick shift) sensor with or without an integrated or aftermarket gear shift lever, clutch sensor with or without an integrated or aftermarket clutch pedal, throttle sensor, brake sensor, or others. The system can include integrated components that are included in an electric vehicle, and can include aftermarket parts for component that are included on traditional fuel engine vehicles but are not included in electric vehicles, such as a gear shift lever, automatic shift lever, paddle shifter, clutch pedal, or others, which components can include sensors as well as haptic feedback devices. The computing system 112 can run an algorithm that considers inputs such as acceleration, turning, speed, or other, and provides a simulation output 116 of the sound (e.g., audio waveform) and/or feel (e.g., audio/visual or haptic).

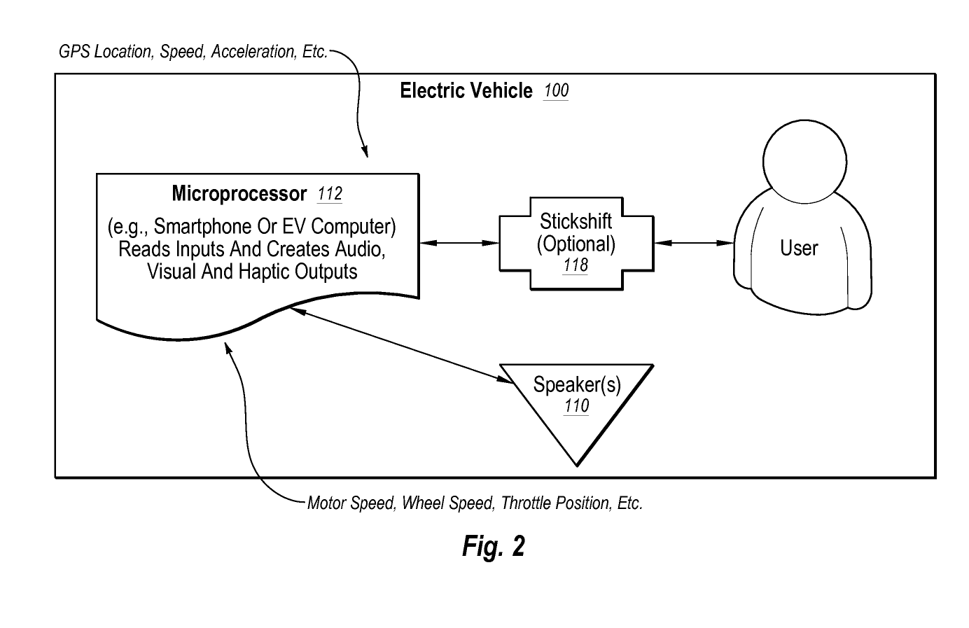

FIG. 2 shows a generic embodiment of data flow from sensors to the computing system. System and method can use data from vehicle sensors to provide data, such as motor speed, wheel speed, throttle position, or the like. The system can use data from mobile device sensors to provide data, such as GPS location, speed, acceleration, or the like. The computing system 112 microprocessor can read the input and create audio, visual, and haptic outputs. This may also include the optional stick shifter 118 or other components. The audio sound of the traditional driving experience can be output by the speakers of the in-vehicle sound system 110. The visual output can be on a dashboard display or other display, which may provide visual simulation of engine RPM, such as a graphical tachometer, or any other driving visual, such as gas level gages even though the electric car does not include a gas tank. The driver can then receive the audio, visual, and haptic outputs to receive the traditional driving experience simulation in the electric vehicle.

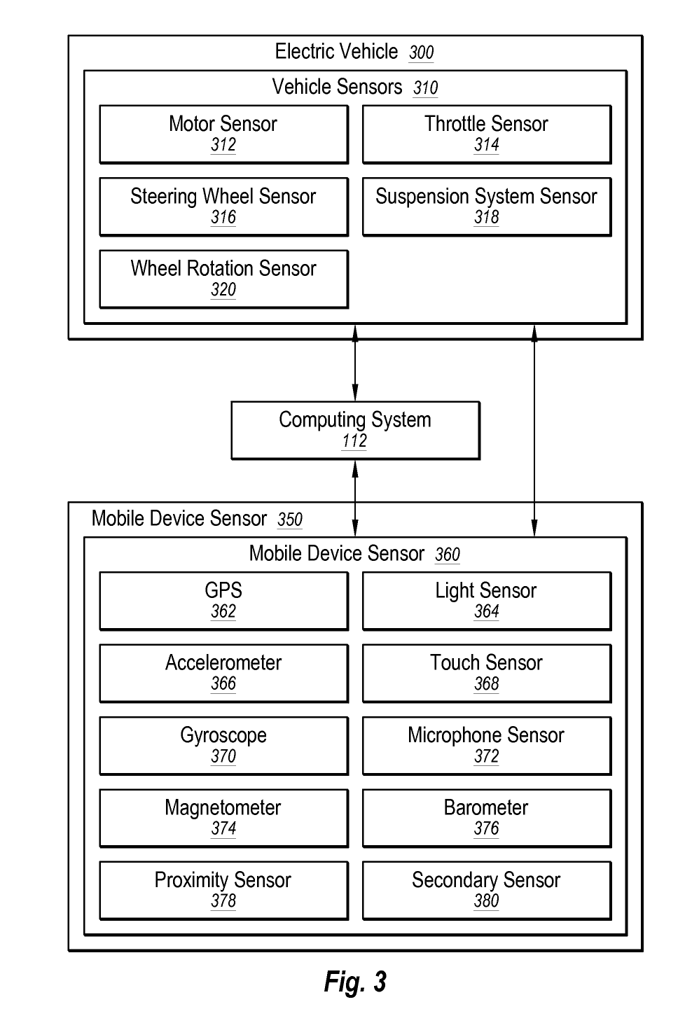

FIG. 3 illustrates vehicle sensors 310 that can obtain electric vehicle driving data from an electric vehicle 300 provide electric vehicle driving data to the computing system. The vehicle sensors 310 can include: motor sensor 312; throttle sensor 314; steering wheel sensor 316; suspension system sensor 318; and wheel rotation sensor 320.

Also, FIG. 3 illustrates mobile device sensors 360 of a mobile device 350 that can provide electric vehicle driving data to the computing system 112. The mobile device sensors 360 include: GPS 362; light sensor 364; accelerometer 366; touch sensor 368; gyroscope 370; microphone sensor 372; magnetometer 374; barometer 376; proximity sensor 378; and secondary sensor 380. However, the mobile device sensors 360 may also be included in an electric vehicle 100. The computing system 112 obtains the data from these sensors, determines the driving output audio, visual and/or feel feedback, and determines how to provide the feedback. The computing system 112 can then provide instruction data to the sound system, dashboard, and haptic devices to provide the feedback to the driver and optionally to the passengers.

In one embodiment, the vehicle and mobile device and electric vehicle can provide data between each other. This can allow for the mobile device to know when the car is being started and/or turned off, which can then provide the data to the mobile device, which allows the mobile device to implement the proper sounds or haptic feedback associated therewith. This can be useful when the mobile device controls the method. However, the method can be used with an electric device having the application when it includes the proper sensors and can execute the application to provide the traditional driving experience simulation without the mobile device.

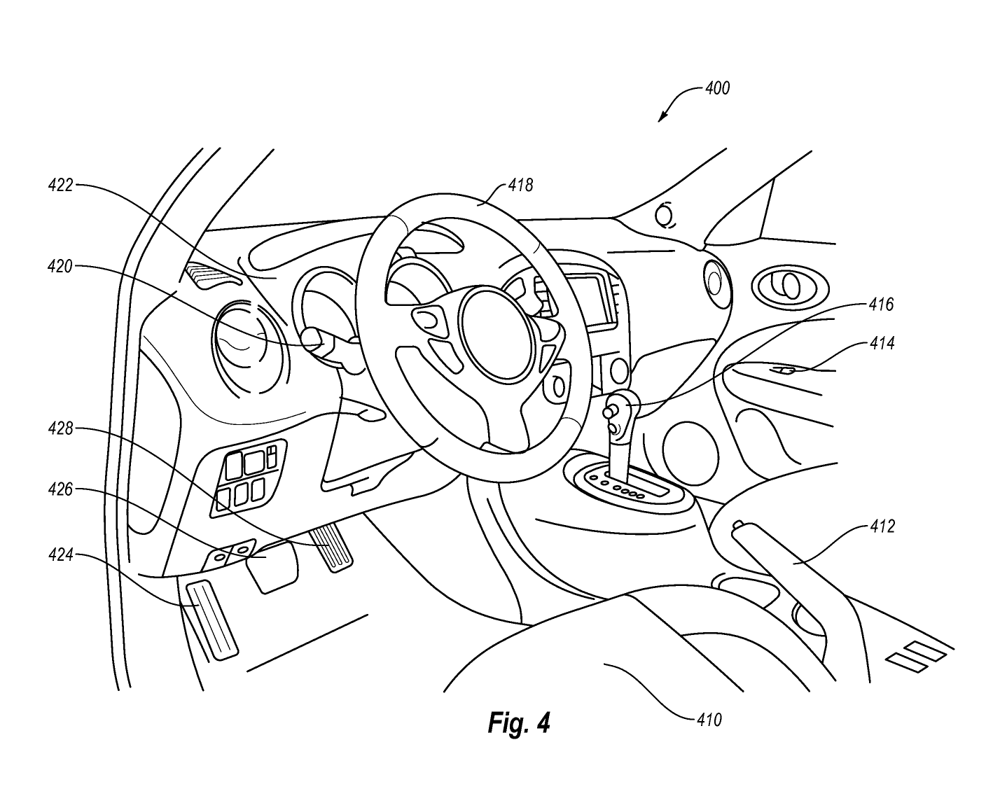

FIG. 4 illustrates components that can be included in an electric vehicle 400 or added thereto to provide traditional driving experience feedback devices. The haptic devices can be applied to the seat 410, emergency brake 412, window switches 414, gear shift lever 416 (e.g., standard or automatic), steering wheel 418, windshield wiper lever 420, dashboard 422, clutch pedal 424, brake pedal 426, accelerator pedal 428, or any other component.

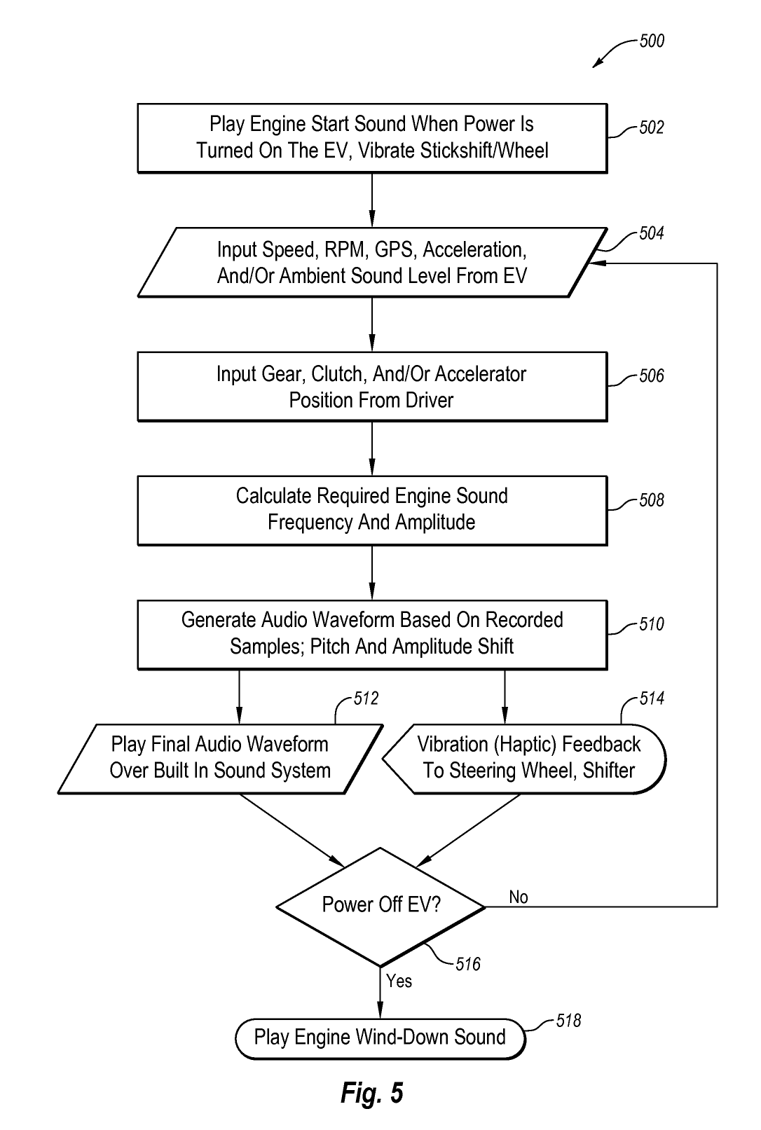

FIG. 5 illustrates a protocol 500 for providing the traditional driving experience simulation. The protocol can include: play engine start sound when power is turned on the EV, vibrate stick shift/wheel (block 502); input speed, RPM, GPS, acceleration, and/or ambient sound level from EV (block 504); input gear, clutch, and/or accelerator position from driver (block 506); calculate required engine sound frequency and amplitude (block 508); generate audio waveform based on recorded samples, such as pitch and amplitude shift (block 510); in one option, play final audio waveform over built-in sound system (block 512); in another option, emit vibration (haptic) feedback to steering wheel, shifter, etc. (block 514); in another option, perform both block 512 and block 514; determine whether or not to power of the EV (block 516); if not powering off, repeat to block 504; and if powering off, then play engine wind-down sound (block 518). Of course, this is an example protocol, and the protocol can vary as described herein.

In one embodiment, the present invention includes a system and method for recording traditional driving experiences in sound and/or vibrations as data for use in the simulation thereof in an electric vehicle. The recording can be via microphone or other sensors for sound, and vibrational-responsive sensors for feel. As such, the system can include various sound and vibration recording devices that can be placed in locations where such sounds and vibrations occur, such as the engine, transmission, gas pedal, brake pedal, clutch pedal, steering wheel, automatic shift lever, gear shift lever, exhaust, or the like. A sensor can be configured for each location. The sensors can be operably coupled to a computing system that can receive and store the recorded data. The system can also be used for data analysis and to determine when (e.g., acceleration and/or speed) to play certain sounds and/or emit haptic feedback during driving an electric vehicle. Such a system and method can be considered to be a traditional driving experience data recording system and method. The data collected thereby can be processed for use. Then, the data can be used in order to provide the recorded traditional driving experience to the electric vehicle for the traditional driving experience simulation.

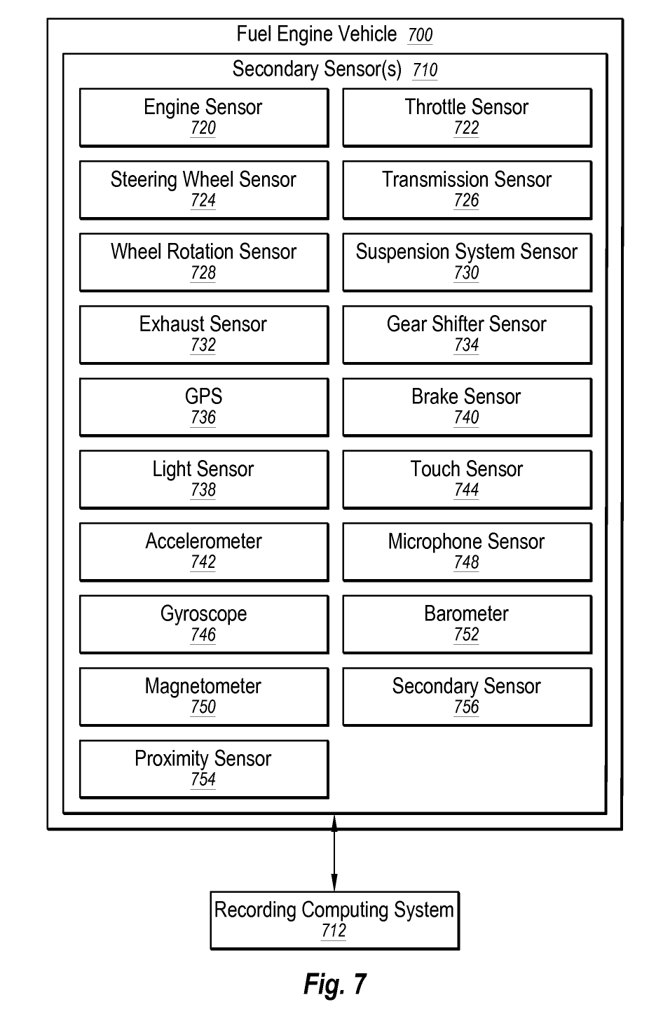

FIG. 7 illustrates sensors 710 that can be used to record a traditional driving experience in a fuel engine vehicle 700, and provide the data to the recording computing system 712. This data can then be used with an electric vehicle as described herein. Some example sensors 710 can include: engine sensor 720; throttle sensor 722; steering wheel sensor 724; transmission sensor 726; wheel rotation sensor 728; suspension system sensor 730; exhaust sensor 732; gear shifter sensor 734; GPS 736; light sensor 738; brake sensor 740; accelerometer 742; touch sensor 744; gyroscope 746; microphone sensor 748; magnetometer 750; barometer 752; proximity sensor 754; and any secondary sensor 756. Secondary sensors can be vehicle specific, such as sensor for a dump bed of a dump truck; back hoe of a tractor; or others.

The sensors of FIG. 7 can be used in a method for recording the traditional driving experience data for use in the systems and methods for providing the traditional driving experience to an electric vehicle. The fuel vehicle 700 can be operated in traditional manners so that the sensors 710 can collect data for acceleration; maintaining speed at various, continuous or a plurality of speeds; decelerating; turning; or other driving. Also, the data can be collected for extreme driving so that extreme driving can be simulated in the electric vehicle, which can include hard accelerations, braking, cornering, or generally driving like in a race car or sports car. Also, truck driving simulations, motorcycle driving simulations, or other vehicle driving simulations can be recorded for use in the electric vehicle. The electric vehicle may include any automobile, truck, motorcycle or other.

In one embodiment, a system for providing a traditional driving experience in an electric vehicle can include: a computing system having one or more memory devices with traditional driving experience data of a fuel engine vehicle and computer executable instructions for performing a method for providing the traditional driving experience; one or more sensors to sense current driving and provide current driving data to the computing system; and an audio system to receive audio feedback data from the computing system in response to the current driving data and provide audio feedback that sounds like the fuel engine vehicle in the electric vehicle. In one aspect, the system can include a haptic feedback device configured to receive haptic feedback data from the computing system so that haptic feedback to simulate the fuel engine vehicle is provided to the electric vehicle, the haptic feedback data being part of the traditional driving experience data. In one aspect, the system can include a haptic feedback device that is selected from a mobile computing device, gear shift lever, steering wheel, accelerator pedal, brake pedal, clutch pedal, dashboard, windshield wiper lever, window switch, emergency brake, or seat. In one aspect, the computing system can include a memory device having executable instructions for: processing the driving data and traditional driving experience data; determining the audio feedback for the driving data in real time; and providing real time audio feedback to the audio system so that the audio feedback corresponds with the driving data to provide a traditional driving experience for the current driving. In one aspect, the system can include the traditional driving experience data being audio data for a vehicle component for a plurality of operating conditions of the vehicle component, and wherein driving data input causes the computing system to match an operating condition with the driving data in order to determine the audio feedback for the current driving. In one aspect, the system can include the traditional driving experience data including one or more of: realistic engine, transmission, exhaust, and/or tire noises; gearshift, steering wheel, seat, and/or pedal haptic feedback; accelerations; and decelerations. In one aspect, the system can include an electric vehicle having the computing system, one or more sensors, and audio system. In one aspect, the system can include the one or more sensors being selected from motor sensor, throttle sensor, steering wheel sensor, suspension system sensor, wheel rotation sensor, GPS, light sensor, accelerometer, touch sensor, gyroscope, microphone, magnetometer, barometer, proximity sensor, and secondary sensor. In one aspect, the system can include the one or more of the sensors being integrated with the electric vehicle and operably coupled with the computing system. In one aspect, the system can include a mobile computing device having at least the computing system and one or more sensors. In one aspect, the system can include the mobile computing device operably coupled with an audio system of an electric vehicle so that audio data provided from the mobile computing device is played on the audio system of the electric vehicle. In one aspect, the system can include the traditional driving experience data having data recorded from a fuel engine vehicle.

In one embodiment, a system for providing a traditional driving experience in an electric vehicle can include: a computing system having traditional driving experience data of a fuel engine vehicle; a sensor to sense current driving and provide driving data to the computing system; and an audio system to provide audio feedback that sounds like the fuel engine vehicle in the electric vehicle. In one aspect, the system can include a haptic feedback device configured to receive haptic feedback data from the computing system so that haptic feedback to simulate the fuel engine vehicle can be provided to the electric vehicle.

In one embodiment, a method of providing a traditional driving experience in an electric vehicle can include: providing an electric vehicle; providing a computing system in the electric vehicle having one or more memory devices with traditional driving experience data of a fuel engine vehicle and computer executable instructions for performing the method; operating the electric vehicle with a subject; and providing the traditional driving experience to the subject operating the electric vehicle, the traditional driving experience including traditional driving audio and/or haptic feedback. In one aspect, the method can include: providing current driving data to the computing system; the computing system analyzing the current driving data; and the computing system determining traditional driving experience data that corresponds with the current driving data. In one aspect, the method can include one or more of the following: playing an engine staring sound when electric vehicle is powered on; inputting current driving data into the computing system; inputting driver data into the computing system; calculating fuel engine sound from driving data and/or driver data; generating audio waveform from calculated fuel engine sound; playing generated audio waveform as audio sound to the subject; determine haptic feedback from driving data and/or driver data; providing haptic feedback to subject; determine whether electric vehicle is operating, and if so continue providing traditional driving audio and/or haptic feedback to the subject; or determine whether electric vehicle is powering off, and if so, play engine wind-down audio. In one aspect, the method can include inputting into the computing system a type of fuel engine vehicle for the traditional driving experience to be provided to the subject while operating the electric vehicle. In one aspect, the system can include inputting into the computing system a type of driving style of the fuel engine vehicle for the traditional driving experience to be provided to the subject while operating the electric vehicle.

In one embodiment, a method for providing a traditional driving experience in an electric vehicle can include: providing the system of the invention; driving the electric vehicle with a driver; and providing the audio feedback and/or haptic feedback to the driver of the electric vehicle.

In one embodiment, a system for recording a traditional driving experience of a fuel engine vehicle can include: one or more sound and/or vibrational sensors configured to record traditional driving experience data of a fuel engine vehicle; and a computing system operably coupled to the one or more sound and/or vibrational sensors so that the recorded traditional driving experience data of a fuel engine vehicle can be stored and/or analyzed. In one aspect, the system can include one or more sound and/or vibrational sensors being selected from engine sensor, throttle sensor, steering wheel sensor, transmission sensor, wheel rotation sensor, suspension system sensor, exhaust sensor, gear shifter sensor, GPS, brake sensor, light sensor, touch sensor, accelerometer sensor, microphone sensor, gyroscope sensor, barometer, magnetometer, secondary sensor, and proximity sensor.

In one embodiment, a method of recording a traditional driving experience of a fuel engine vehicle can include: coupling system for recording a traditional driving experience of a fuel engine vehicle to a fuel engine vehicle; operating the fuel engine vehicle; and recording the sound and/or vibrational data from the one or more sound and/or vibrational sensors.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In one embodiment, the present methods can include aspects performed on a computing system. As such, the computing system can include a memory device that has the computer-executable instructions for performing the method. The computer-executable instructions can be part of a computer program product that includes one or more algorithms for performing any of the methods of any of the claims.

In one embodiment, any of the operations, processes, methods, or steps described herein can be implemented as computer-readable instructions stored on a computer-readable medium. The computer-readable instructions can be executed by a processor of a wide range of computing systems from desktop computing systems, portable computing systems, tablet computing systems, hand-held computing systems as well as network elements, base stations, femtocells, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

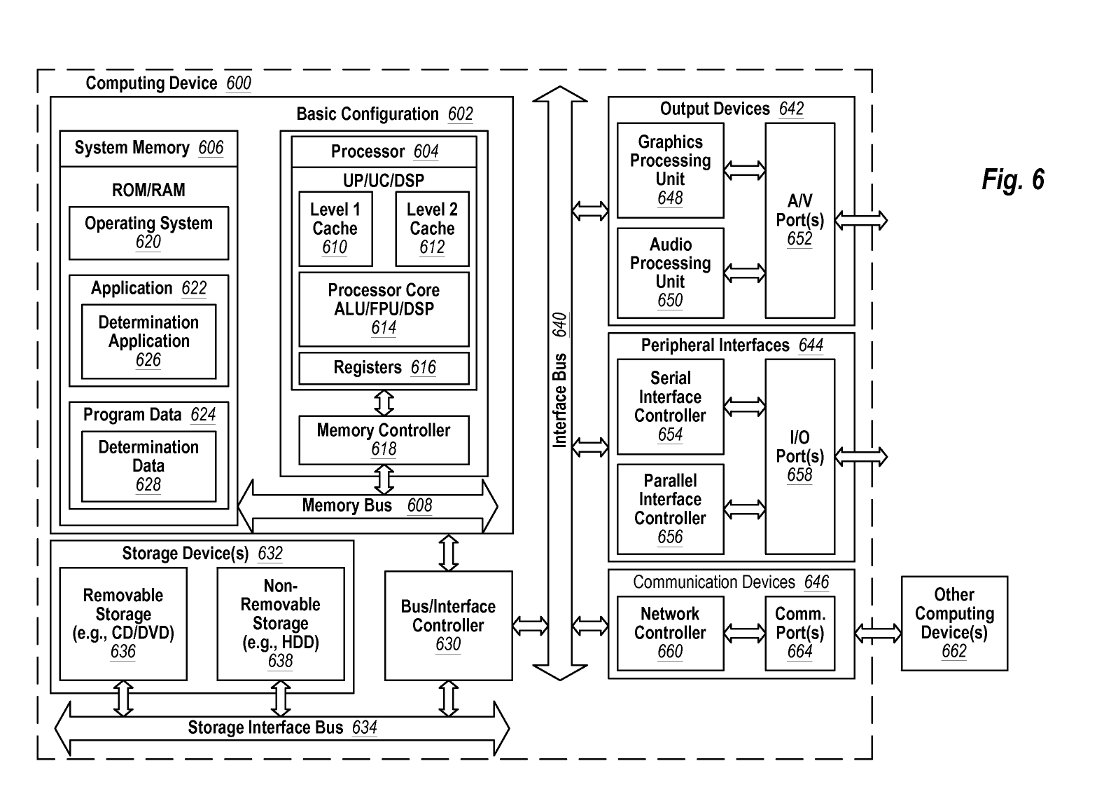

FIG. 6 shows an example computing device 600 that is arranged to perform any of the computing methods described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. Program Data 624 may include determination information 628 that may be useful for analyzing the contamination characteristics provided by the sensor unit 240. In some embodiments, application 622 may be arranged to operate with program data 624 on operating system 620 such that the work performed by untrusted computing nodes can be verified as described herein. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A system for providing a traditional driving experience in an electric vehicle, the system comprising:
a computing system having one or more memory devices with traditional driving experience data of a fuel engine vehicle and computer executable instructions for performing a method for providing the traditional driving experience;
one or more sensors to sense current driving and provide current driving data to the computing system; and
an audio system to receive audio feedback data from the computing system in response to the current driving data and provide audio feedback that sounds like the fuel engine vehicle in the electric vehicle.

2. The system of claim 1, comprising a haptic feedback device configured to receive haptic feedback data from the computing system so that haptic feedback to simulate the fuel engine vehicle is provided to the electric vehicle, the haptic feedback data being part of the traditional driving experience data.

3. The system of claim 2, wherein the haptic feedback device is selected from a mobile computing device, gear shift lever, steering wheel, accelerator pedal, brake pedal, clutch pedal, dashboard, windshield wiper lever, window switch, emergency brake, or seat.

4. The system of claim 1, wherein the computing system includes a memory device having executable instructions for:
processing the driving data and traditional driving experience data;
determining the audio feedback for the driving data in real time; and
providing real time audio feedback to the audio system so that the audio feedback corresponds with the driving data to provide a traditional driving experience for the current driving.

5. The system of claim 1, wherein the traditional driving experience data includes audio data for a vehicle component for a plurality of operating conditions of the vehicle component, and wherein driving data input causes the computing system to match an operating condition with the driving data in order to determine the audio feedback for the current driving.

6. The system of claim 1, wherein the traditional driving experience data includes one or more of: realistic engine, transmission, exhaust, and/or tire noises; gearshift, steering wheel, seat, and/or pedal haptic feedback; accelerations; and decelerations.

7. The system of claim 1, comprising: an electric vehicle having the computing system, one or more sensors, and audio system.

8. The system of claim 7, wherein the one or more sensors are selected from motor sensor, throttle sensor, steering wheel sensor, suspension system sensor, wheel rotation sensor, GPS, light sensor, accelerometer, touch sensor, gyroscope, microphone, magnetometer, barometer, proximity sensor, and secondary sensor.

9. The system of claim 7, wherein one or more of the sensors are integrated with the electric vehicle and operably coupled with the computing system.

10. The system of claim 1, comprising: a mobile computing device having at least the computing system and one or more sensors.

11. The system of claim 10, comprising the mobile computing device operably coupled with an audio system of an electric vehicle so that audio data provided from the mobile computing device is played on the audio system of the electric vehicle.

12. The system of claim 1, wherein the traditional driving experience data includes data recorded from a fuel engine vehicle.

13. A method of providing a traditional driving experience in an electric vehicle, the method comprising:
providing an electric vehicle;
providing a computing system in the electric vehicle having one or more memory devices with traditional driving experience data of a fuel engine vehicle and computer executable instructions for performing the method;
operating the electric vehicle with a subject; and
providing the traditional driving experience to the subject operating the electric vehicle, the traditional driving experience including traditional driving audio and/or haptic feedback.

14. The method of claim 13, comprising:
providing current driving data to the computing system;
the computing system analyzing the current driving data; and
the computing system determining traditional driving experience data that corresponds with the current driving data.

15. The method of claim 13, comprising one or more of the following:
playing an engine staring sound when electric vehicle is powered on;
inputting current driving data into the computing system;
inputting driver data into the computing system;
calculating fuel engine sound from driving data and/or driver data;
generating audio waveform from calculated fuel engine sound;
playing generated audio waveform as audio sound to the subject;
determine haptic feedback from driving data and/or driver data;
providing haptic feedback to subject;
determine whether electric vehicle is operating, and if so continue providing traditional driving audio and/or haptic feedback to the subject; or
determine whether electric vehicle is powering off, and if so, play engine wind-down audio.

16. The method of claim 13, inputting into the computing system a type of fuel engine vehicle for the traditional driving experience to be provided to the subject while operating the electric vehicle.

17. The method of claim 13, inputting into the computing system a type of driving style of the fuel engine vehicle for the traditional driving experience to be provided to the subject while operating the electric vehicle.

18. A system for recording a traditional driving experience of a fuel engine vehicle, the system comprising:
one or more sound and/or vibrational sensors configured to record traditional driving experience data of a fuel engine vehicle; and
a computing system operably coupled to the one or more sound and/or vibrational sensors so that the recorded traditional driving experience data of a fuel engine vehicle can be stored and/or analyzed.

19. The system of claim 18, wherein the one or more sound and/or vibrational sensors are selected from engine sensor, throttle sensor, steering wheel sensor, transmission sensor, wheel rotation sensor, suspension system sensor, exhaust sensor, gear shifter sensor, GPS, brake sensor, light sensor, touch sensor, accelerometer sensor, microphone sensor, gyroscope sensor, barometer, magnetometer, secondary sensor, and proximity sensor.

20. A method of recording a traditional driving experience of a fuel engine vehicle, the method comprising:
coupling the system of claim 18 to a fuel engine vehicle;
operating the fuel engine vehicle; and
recording the sound and/or vibrational data from the one or more sound and/or vibrational sensors.
